(19) United States
(12) Patent Application Publication
(10) Pub. No.: US 2014/0172499 A1
(43) Pub. Date: Jun. 19, 2014

(54) SYSTEMS AND METHODS PROVIDING CONTENT RATINGS BASED ON ENVIRONMENTAL FACTORS

(71) Applicant: UNITED VIDEO PROPERTIES, INC., Santa Clara, CA (US)

(72) Inventor: Thomas Steven Woods, Arlington Heights, IL (US)

(73) Assignee: UNITED VIDEO PROPERTIES, INC., Santa Clara, CA (US)

(21) Appl. No.: 13/716,713

(22) Filed: Dec. 17, 2012

(51) Int. Cl. G06Q 30/02

(52) U.S. Cl. CPC G06Q 30/0201
USPC 705/7.29

(57) ABSTRACT

Methods and systems for tracking user ratings based on release date and rerelease date of a media asset in an interactive media guidance application for display on a device. Methods and systems are provided to compute and store, in a first data structure, a plurality of initial ratings of a media asset made available to a plurality of users for a threshold period of time. After the media asset is rereleased, methods and systems are provided to independently compute and store, in another data structure, rereleased user ratings of the media asset made available to users after the threshold period of time has passed. Methods and systems are provided to generate a simultaneously independent display of the initial rating and retransmission rating of the media asset.

### BACKGROUND

Media content ratings are completed in a very subjective manner. Today, ratings are based upon a user's opinion of the content at the initial release date and this ratings data is accumulated from a plurality of users who have also rated the content. The vast majority of content ratings are generated within a short time-frame following the initial release date of the media content. Older media content, released before user or critic ratings were being processed, are also only rated for a short time-frame after its release. Media content rereleased, after a threshold period of time passes, has only the initial ratings, and does not independently generate media content ratings based on the rerelease of the media content.

Media content ratings completed in only a short time-frame following its initial release skews ratings results when users are making future viewing choices of rereleased media content. Additionally, a user's ratings of the media content are highly influenced by the time period the ratings were generated and environmental factors which a user may base their opinion on. Environmental factors which impact how a user will rate content may include topical news, social/political trends, popular sports, popular fashion, and cutting edge technology.

More and more users are re-discovering old media content and viewing the content 1-20+ years after their initial release date. In addition, many media content sources are obtaining agreements to transmit reruns or rereleases of media content. Therefore, because there may be a long period of time between initial release and rerelease of the media content, the initial media content ratings associated with the media content may be obsolete.

### SUMMARY OF DISCLOSURE

In order to track media content ratings based on release date of the media content, methods and systems are provided herein for an interactive media guidance application that can independently display content ratings of a media asset based on the initial release date or the initial transmission date of the media asset and on the retransmitted date of the media asset. Additionally, the media content ratings of a media asset may account for the impact environmental factors have on user's opinion of the content ratings. Environmental factors which impact how a user will rate content may include topical news, social/political trends, popular sports, popular fashion, and cutting edge technology.

In some embodiments, control circuitry computes and stores, in a first data structure, a plurality of first media asset ratings when the media asset is initially made available to a plurality of users for a threshold period of time. After the media asset is rereleased, the control circuitry independently computes and stores, in another data structure, a plurality of second media asset ratings when the media asset is made available to a plurality of users after the threshold period of time has passed. The control circuitry generates a simultaneously independent display of the first media asset rating and the second media asset rating.

In some embodiments, the first media asset rating is computed by averaging the plurality of first media asset ratings. In addition, the second media asset rating is computed by averaging the second plurality of media asset ratings.

In some embodiments, the first media asset ratings stored in the first data structure does not change after the threshold period of time is reached. For example, stored user ratings of a theatrical release will not change after the movie is no longer in theaters.

In some embodiments, the second media asset ratings stored in another data structure dynamically changes based on a plurality of media asset ratings received after the threshold period of time of the initial release has passed. For example, user ratings of a television broadcast of a previous theatrical movie release after the movie is no longer in theaters will dynamically change depending on the time-frame the rereleased movie is transmitted for viewing.

In some embodiments, the threshold period of time corresponds to a length of time measured from when the media asset is first made available to when the media asset is syndicated.

In some embodiments, the threshold period of time corresponds to a length of time measured from when a media asset is first made available from a first media content source to when the media asset is made available from a second source, which may be different from the first source. For example, a first source may be a theatrical movie and a second source may be a DVD/Blu-Ray release.

In some embodiments, the second source may include a secondary form of distribution to a user. The secondary form of distribution may include transmission of the media asset to a plurality of user equipment devices from a server. The media asset may be stored on a digital storage device accessible to a user.

In some embodiments, a simultaneous display of the first and second media asset rating comprises visual indicator such as a numerical rating, a star rating, or a color-coding which differentiates the first and second media asset rating. For example, the first media asset rating is in a first color, and the second media asset rating is in a second color.

In some embodiments, the first media asset rating may be the same as the second media asset rating. In response to the ratings being nearly the same or the same, a color-code showing the first and second media asset ratings to be similar is displayed.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative interactive media guidance application that may be used to display portions of media assets in accordance with some embodiments of the disclosure;

FIG. 2 shows an illustrative interactive media guidance application that may be used to display portions of media assets in a series in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative interactive media guidance application that may be used to display media content ratings of initially released media assets in accordance with some embodiments of the disclosure;

FIG. 6 shows an illustrative interactive media guidance application that may be used to display media content ratings of initially released media assets in a series in accordance with some embodiments of the disclosure;

FIG. 7 shows an illustrative interactive media guidance application that may be used to display media content ratings of retransmitted media assets in accordance with some embodiments of the disclosure;

FIG. 8 shows an illustrative interactive media guidance application that may be used to display media content ratings of retransmitted media assets in a series in accordance with some embodiments of the disclosure;

FIG. 9 is a flowchart of illustrative steps involved in using an interactive media guidance application to generate a display of media content ratings of an initially released media asset in accordance with some embodiments of the disclosure;

FIG. 10 is a flowchart of illustrative steps involved in using an interactive media guidance application to generate a display of media content ratings of a retransmitted media asset in accordance with some embodiments of the disclosure;

FIG. 11 shows an illustrative interactive media guidance application that may be used to simultaneously display media content ratings of initially released rating and retransmitted rating in accordance with some embodiments of the disclosure; and

FIG. 12 is a flowchart of illustrative steps involved in using an interactive media guidance application to generate a simultaneous display of media content ratings for the same media asset in accordance with some embodiments of the disclosure.

### DETAILED DESCRIPTION OF EMBODIMENTS

Methods and systems for an interactive media guidance application that can identify and display content ratings of a media asset based on the initial release date of the media asset and separately based on the retransmit date of the media asset. Additionally, the content ratings of a media asset may account for the impact environmental factors have on the content ratings. In some embodiments, the interactive media guidance application may generate a visual indicator which distinguishes the content ratings of the initial release date of a media asset from the content ratings of the retransmission of the same media asset when content ratings are simultaneously displayed.

In some embodiments, the interactive media guidance application content ratings system of a media asset may be impacted by changing environmental factors such as news, social/political trends, popular sports, popular fashion, and cutting edge technologies at the time of the initial release date of the media asset and, separately, at the time of the retransmit of the same media asset.

For example, there was news stories of an asteroid heading toward earth when “Armageddon” was first released in theaters in 1998. Thus, environmental factors, such as topical news may have an impact on user ratings of “Armageddon” during its initial release. The threshold period of time for receiving user ratings of “Armageddon” may be during its initial release in theaters, after which the initial user rating of “Armageddon” does not change. A user rating of a DVD or on-demand release of “Armageddon” in 2000 may be different because of different environmental factors in 2000. When a user rating of the DVD or on-demand release is received, the threshold period of time for receiving user rating of its initial release in theaters has passed. Therefore, user rating of the DVD or on-demand release of “Armageddon” may dynamically change over time. Furthermore, an additional rerelease in 2012 of “Armageddon” may again be of significance because of news stories related to the Mayan prediction of the end of the world in 2012, which may change a user's rating of the film. Therefore, user content rating of “Armageddon” may be different in its initial theatrical release in 1998, its DVD or on-demand release in 2000 and its rerelease in 2012 because of environmental factors during that period of time.

In some embodiments, the interactive media guidance application may generate a visual indicator which distinguishes the content ratings of the initial release date of a media asset from the content ratings of the retransmission of the same media asset when content ratings are simultaneously displayed. In addition, if the content ratings of the media asset when it was initially released and the content ratings of the media asset when it is retransmitted is substantially the same, the interactive media guidance application may generate another visual indicator for the user.

For example, the user content rating of “Armageddon” may be different in 1998 and 2000. The interactive media guidance application may generate unique visual indicators which distinguish user content ratings from 1998 and 2000. Furthermore, user content ratings in 2012 may be similar to user content ratings in 1998. Therefore, the visual indicator of user content ratings from the initial release in 1998 may be represented by a first color and the visual indicator of user ratings from the second release in 2000 may be represented by a color different from the first color. The user rating from a transmission in 2012 may be similar to the initial release in 1998. The user rating from 2012 may be averaged into the user ratings from the second release in 2000 and be represented as part of the visual indicator of user ratings from the second release in 2000.

In some embodiments, the media content ratings system of the interactive media guidance application for a media asset may be impacted by changing environmental factors, which may include other media assets, such as news, social/political trends, popular sports, popular fashion, and cutting edge technologies at the time of the initial release date of the media asset and separately at the time of the retransmission of the same media asset. As user's opinions of programs change based on the time the media asset is presented and a user is influenced by environmental factors, which may include other media assets, content rating of the media asset may change accordingly. In some embodiments, the interactive media guidance application content ratings system may account for these environmental factors.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

Today, program ratings media guidance data is completely subjective. Ratings are predominantly based on a user's opinion of the program and this data is accumulated amongst a plurality of users who also rate the program. The vast majority of program ratings are generated within a short-time frame following the initial release of a program. These initial program ratings may be influenced by the time they were generated and the environmental factors influencing a user's opinion. For example, topical news, social/political trends, popular sports, popular fashion, and cutting edge technology are all factors which may influence a user's rating of a program. However, more and more people are rediscovering retransmitted programs. In addition, many media content sources are obtaining agreements to broadcast reruns of programs. Therefore, in addition to the initial program ratings, a new rating of re-discovered or reruns of programs may be more appropriate in informing the user when deciding programming content to view. Providing the user with various program ratings and taking into account the environmental factors influencing the program ratings will improve upon the user viewing decision.

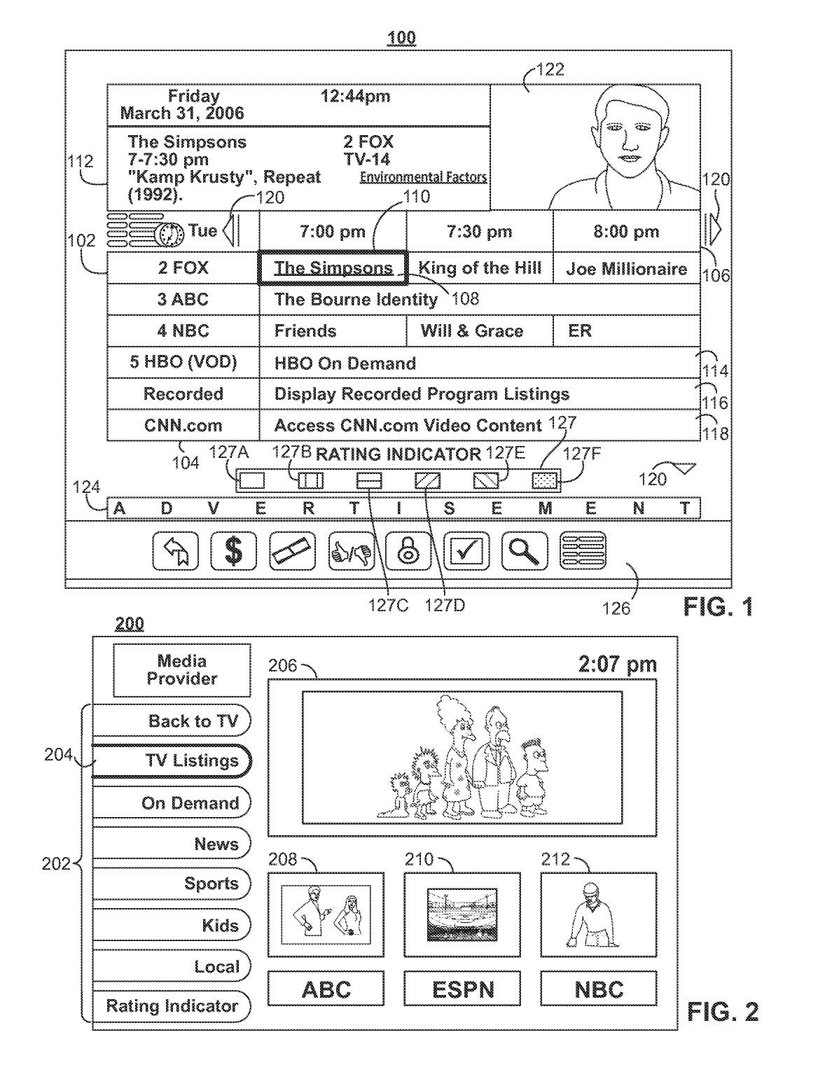

FIGS. 1-2 show illustrative display screens that may be used to provide media guidance data. The display screens shown in FIGS. 1-2, 5-8, and 11 may be implemented on any suitable user equipment device or platform. While the displays of FIGS. 1-2, 5-8, and 11 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. Region 112A provides current time, day, and date. With a user input device, a user can select program listings by moving highlight region 110. Information relating to the program listing selected by highlight region 110 may be provided in program information region 112B. Region 112B may include, for example, the program title, the program description, the time the program is provided (if applicable), the channel the program is on (if applicable), the program's rating (if applicable), a brief description of environmental factors (or a link to content contributing to environmental factors) associated with the rating (if applicable), and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120).

Display 100 may also include video region 122, advertisement 124, options region 126, and rating indicator region 127. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The rating indicator region 127 may provide a visual guide representing user ratings of the media asset in display 100. The visual indicators 127A-127E represent a visual range of user rating based on a user rating scale configurable by control circuitry 304, as described below. The user rating scale may be any configurable rating system, such as a numerical rating system, a percentage rating system, a graded rating system, a star rating system or a color-coded rating system, as described below. The visual indicator 127A represents the lowest user rating of a media asset based on a user rating scale configured by control circuitry 304. The visual indicator 127E represents the highest user rating of a media asset based on a user rating scale configured by control circuitry 304. The visual indicator 127F represents the user rating of a media asset when the user rating of the media asset's initial release and user rating of the media asset's rerelease are substantially equal. Additional embodiments of the visual indicators 127A-127F are described below.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

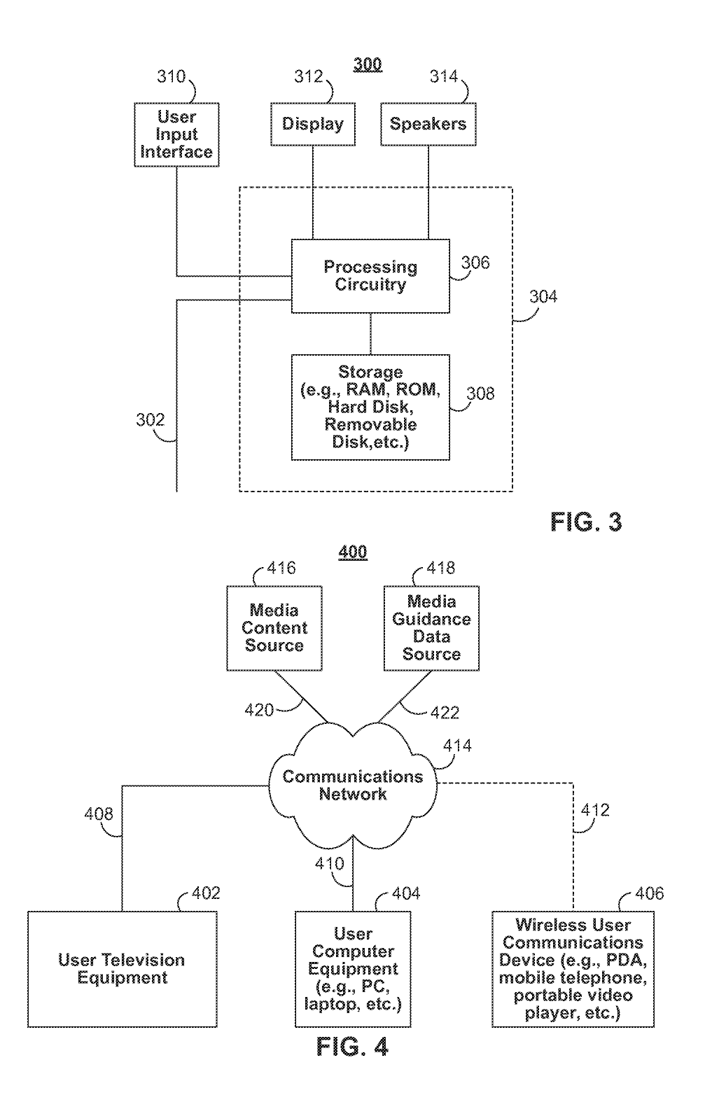

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths.

Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below). If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, which provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user equipment device may receive content from multiple cloud resources simultaneously. For example, a user equipment device can stream audio from one cloud resource while downloading content from a second cloud resource. Or a user equipment device can download content from multiple cloud resources for more efficient downloading. In some embodiments, user equipment devices can use cloud resources for processing operations such as the processing operations performed by processing circuitry described in relation to FIG. 3.

Program ratings are based on a user's opinion of the program. A user's opinion may be influenced by the environmental factors during the time period the program was initially released for broadcast. Environmental factors may include news, social/political trends, popular sports, popular fashion, and cutting edge technology.

For example, the NFL Super Bowl, is a very popular live sporting event. In the 2012 Super Bowl XLVI, the New York Giants played the New England Patriots. The threshold period of time for receiving user rating of a live sporting event may be only for the time the live event airs. After the live sporting event is completed, user rating received for the program may not be associated with the initial rating of the live sporting event. In addition, in this example, because the matchup was the same as the 2008 Super Bowl XLII, user ratings of the 2012 Super Bowl XLVI may be influenced by the previous matchup in the 2008 Super Bowl XLII. Furthermore, a 2012 rerelease of the 2008 Super Bowl XLII may change user rating based on the current time period and environmental factors. Moreover, a user's opinion on a preferred team or player may factor into a user's rating of the Super Bowl. Many non-sports users still watch the NFL Super Bowl for the initial release of advertisements. The advertisements shown during the NFL Super Bowl are very popular, and may also factor into a user's opinion of the NFL Super Bowl, and separately, the products being advertised. The threshold time period for separately receiving user rating of an advertisement may not be the same as the live sporting event. The threshold time period of the advertisement may be set by the advertiser. In some embodiments, the threshold time period of the advertisement may depend on the environmental factors influencing the product being advertised. For example, a seasonal product may have a threshold time period of four months. Furthermore, a year-round product may have a threshold time period of 12 months.

In some embodiments, a user's opinion of products in advertisements may also be influenced by environmental factors including news, social/political trends, popular sports, popular fashion, and cutting edge technology, during the time period the advertisement was released for viewing. The user's opinion may change after the threshold time period has passed. For example, a retransmission of the advertisements initially released during the NFL Super Bowl, may have a different user rating based on the time period and environmental factors at the time the user rates the media content or media advertisement. Region 112 of FIG. 1 may describe environmental factors or may provide a link to environmental factors that may be influencing a user's opinion.

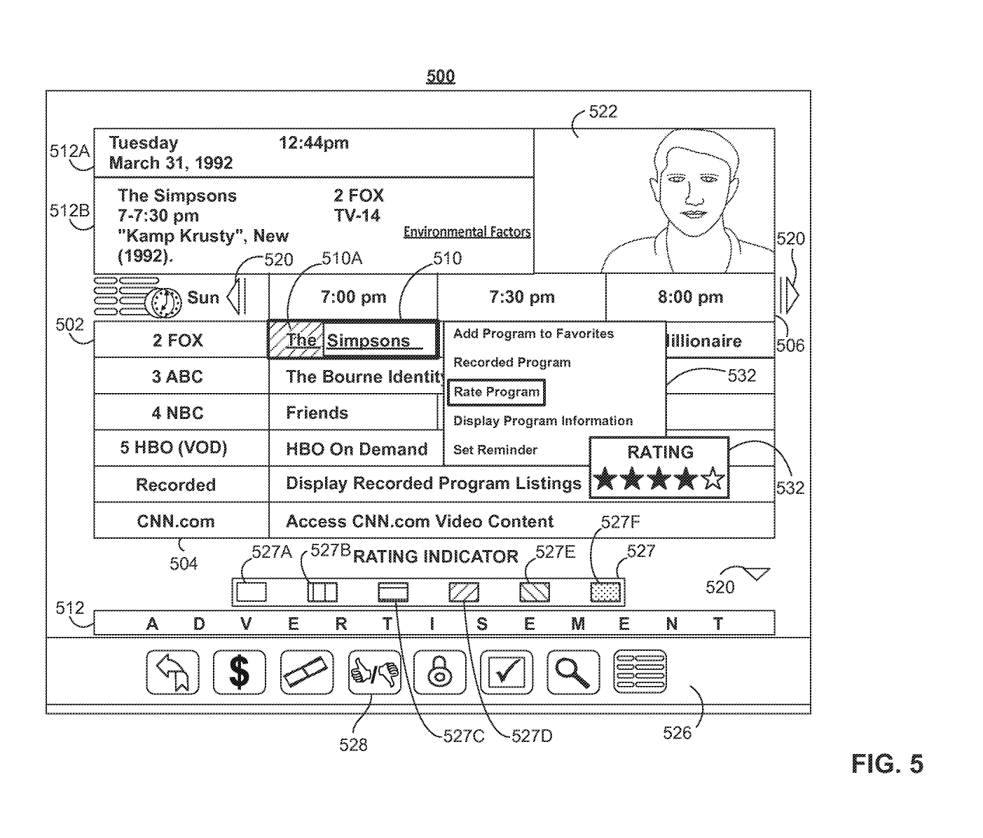

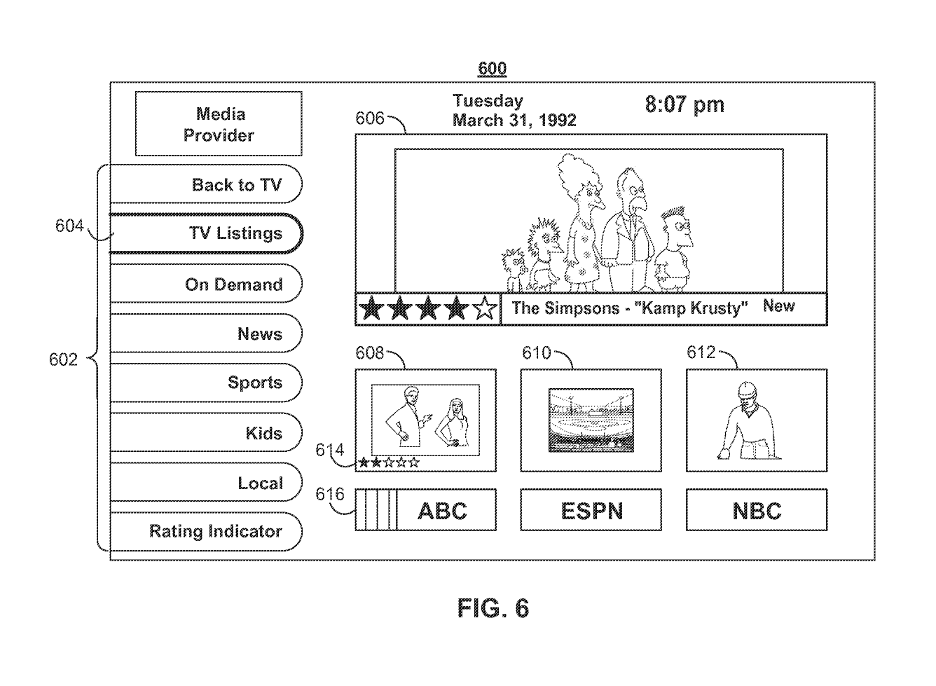

FIG. 5 shows illustrative grid program listings display 500 arranged by time and channel that also enables access to different types of content in a single display on user equipment device 300 by display 312. Display screen 500 may be similar to the display screen 100 as described above. Display 500 may include grid 502 with: (1) a column of channel/content type identifiers 504, where each channel/content type identifier (which is a cell in the column) identifies a different channel or content type available; and (2) a row of time identifiers 506, where each time identifier (which is a cell in the row) identifies a time block of programming. Grid 502 also includes cells of program listings, such as program listing 508, where each listing provides the title of the program provided on the listing's associated channel and time. Region 512A provides current time, day, and date. With a user input device, a user can select program listings by moving highlight region 510. Information relating to the program listing selected by highlight region 510 may be provided in program information region 512B. Region 512B may include, for example, the program title, the program description, the time the program is provided (if applicable), the channel the program is on (if applicable), the program's rating (if applicable), a brief description of environmental factors (or a link to content contributing to environmental factors) associated with the rating (if applicable), and other desired information.

For example, from region 512A, the current time, day, and date is 2:44 pm on Tuesday, Mar. 31, 1992 and region 512B is displaying program listing information associated with highlight region 510. The highlight region 510, is on “The Simpsons,” and region 512B displays a new episode, “Kamp Krusty,” to be shown at 7 pm. Region 512B may describe environmental factors or may provide a link to environmental factors that may be influencing a user's opinion. The new episode “Kamp Krusty” is the initial release. This information is generated by control circuitry 304 and transmitted for display on user equipment device 300 by display 312. With a user input device, a user can select the rating icon 528 from options region 526 of the interactive media guidance application to rate the program associated with highlight region 510. The control circuitry 304 processes the user input and generates an overlay display 530 for display on user equipment device 300 by display 312. The overlay display 530 has several user selectable options using a user input device. The user may scroll up/down to select an option from overlay display 530. From the overlay display 530, a user selection to “Rate Program” is transmitted from the user input device to the user equipment device 300. The control circuitry 304 receives user input to rate the program and transmits instructions to display overlay rating display 532 for display on user equipment device 300 by display 312 as an overlay onto interactive media guidance display 500. The user selects the rating using the left/right scroll buttons on a user input device. The user content rating is transmitted from the user input device to the user equipment device 300. The control circuitry 304 receives user content rating of the program and stores the media asset rating in a data structure in storage 308 in control circuitry 304.

For example, the user rates “The Simpsons” program, new episode “Kamp Krusty” with a 4 out of 5 stars. The rating system in overlay rating display 532 is one embodiment. In some embodiments, the rating system may be numerically based. For example, user rating of content may be on a scale from 1 to 10 or a percentage from 1 to 100%. In other embodiments, the rating system may be graded. For example user rating of content may be A, B, C, D, and F, with additional plus/minus ratings input by the user, using the user input device. The rating system may be different based on the media content. For example, Internet-based content rating may be based on the number of views, and on-demand content may be based on the number of orders to view the content.

The user rating for the initially released program may be stored in a first data structure in storage 308. A remote server, having hardware as described in FIG. 3, receives the user rating which may be stored in the first data structure in storage 308. The remote server computes an average of the user rating from a plurality of user ratings stored in storage 308 for the initially released program. The remote server continues to compute the average user rating of the initially released program until the threshold period of time configured by the control circuitry 304 has been reached. The plurality of user ratings are received from a plurality of user equipment devices 300, wherein a user inputs a rating using a user input device. The computed average of the user ratings for the initially released media asset is transmitted for storage in the first data structure of storage 308. The computed average of the user ratings for the initially released media asset stored in the first data structure of storage 308 will not change after the difference between the current time and the threshold period of time of the initial release configured by the control circuitry is equal or greater. The control circuitry 304 transmits the computed average initial user rating for display on user equipment device 300 by display 312. The visual indicator 510A is the computed average initial user rating displayed on the interactive media guidance application. The threshold time period for receiving user rating for the initial release of a media asset may depend on the media asset itself. For example, all the episodes in the current season of “The Simpsons” would be considered the initial release during the airing of “The Simpsons” during the season. When the next season of new episodes of “The Simpsons” airs, all the episodes in the current season may be considered past the threshold time period of the initial release. In some embodiments, the threshold time period for all the episodes in the current season may be after “The Simpsons” has been in syndication for an established time period.

Another display arrangement for providing media guidance is shown in FIG. 6. Video mosaic display 600 may be similar to the video mosaic display 200 as described above. Video mosaic display 600 includes current time, day, and date information and selectable options 602 for content information organized based on content type, genre, and/or other organization criteria. In display 600, television listings option 604 is selected, thus providing listings 606, 608, 610, and 612 as broadcast program listings. In display 600, rating indicator option may be selected to show the visual indicator guide representing user ratings of the media asset. In display 600 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. In listing 606, program information, including ratings may be displayed.

For example, in listing 606, the new episode, “Kamp Krusty,” of “The Simpsons,” has a 4 out of 5 stars rating displayed as text over a portion of listing 606. Additionally, listing 608 may include more than one portion, including media portion 614 and text portion 616. Media portion 614 and/or text portion 616 may be selectable to view content in full-screen or to view information related to the content displayed in media portion 614 (e.g., to view listings for the channel that the video is displayed on). In display 600, rating indicator option may be selected to show the visual indicator guide representing user ratings of the media asset. For example, the program ratings information may be visually indicated in media portion 614 as a star rating and separately a visual indication in the text portion 616 as a color-coded rating.

As more and more users re-discover previously released programs and view content 1-20 years after their initial release date of the program, an updated rating of the retransmitted program may be more appropriate in informing the user when program viewing decisions are made. The retransmitted programs viewed and rated by the user at a later date are important because the ratings are not influenced by the same set of environmental factors which influenced the initial program ratings. Therefore, a more appropriate current set of program ratings, in addition to the initial program ratings, would provide a user with improved information when making a program viewing decision.

For example, popular holiday themed songs have not changed over the last 1-20 years. However, during this time, popular artists have rerecorded these holiday themed songs. Users are reminded of the same song when it is rereleased or rerecorded and released. For example, “Silent Night” is a popular Christmas carol originally composed in 1818 in Austria. In the modern era, artists such as Frank Sinatra (1948), Mariah Carey (1994), and Destiny's Child (2007) have rerecorded this carol for wide release; in addition to the environmental factors at the time (1948, 1994, 2007) the rerecorded carol was released. The user rating of “Silent Night” for different versions may be influenced by the recording artist as well. In this example, the original release of “Silent Night” in 1818 may not have user content ratings which can be correlated to current user ratings, however, a dynamic change in user ratings of “Silent Night” based on the time period and environmental factors, may be computed and stored. The threshold period of time for receiving user ratings may be configured to be seasonal. Therefore, in this example, the threshold period of time for receiving the user ratings of the initial release of the media asset may be four months. The user ratings up to the threshold period of time following the initial release of the media asset are stored in a first data structure in storage 308 associated with the media asset. After the four months have passed, user ratings of the media asset may not be of the initial release. Instead the user ratings after the four months have passed may be the syndicated or other alternative release of the media asset. The user ratings after the threshold period of four months have passed are stored in a data structure different from the first data structure in storage 308 associated with the media asset. In this example, the media asset “Silent Night” recorded by Frank Sinatra, may have up to three unique ratings, from its initial release in 1948 and again in 1994 and 2007. The “Silent Night” recordings by Mariah Carey, may have up to two unique ratings, from its initial release in 1994 and again in 2007.

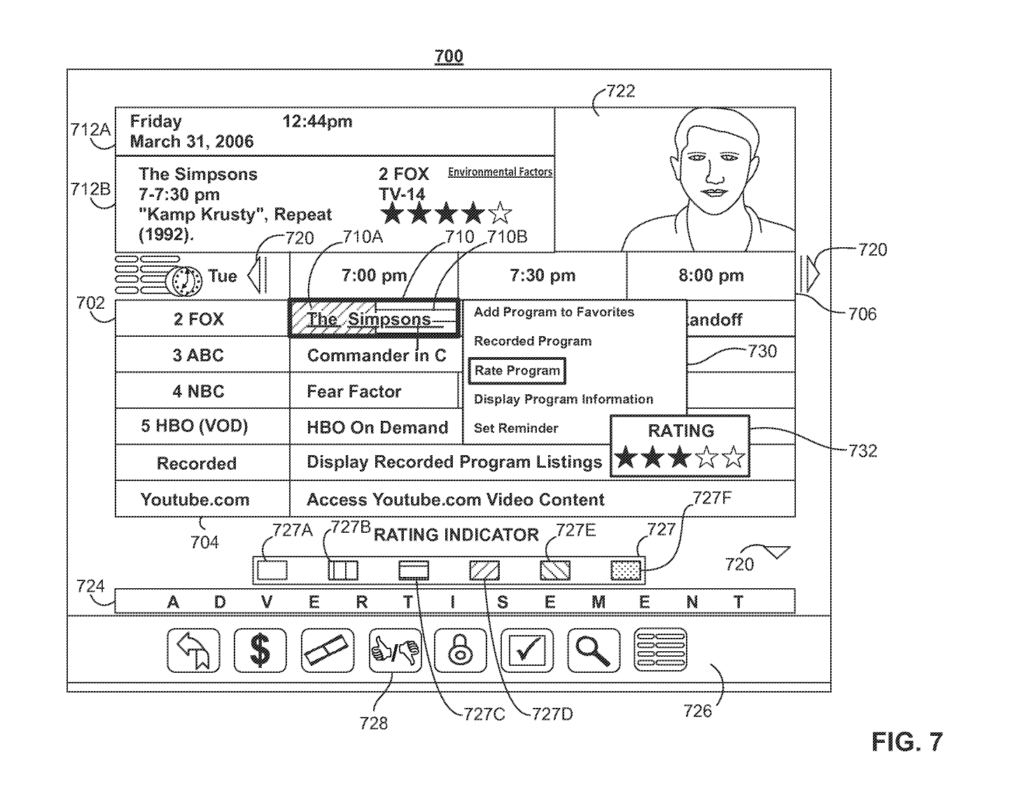

FIG. 7 shows illustrative grid program listings display 700 arranged by time and channel that also enables access to different types of content in a single display on user equipment device 300 by display 312. Display screen 700 may be similar to the display screen 100 and display screen 500 as described above. Display 700 may include grid 702 with: (1) a column of channel/content type identifiers 704, where each channel/content type identifier (which is a cell in the column) identifies a different channel or content type available; and (2) a row of time identifiers 706, where each time identifier (which is a cell in the row) identifies a time block of programming. Grid 702 also includes cells of program listings, such as program listing 708, where each listing provides the title of the program provided on the listing's associated channel and time. Region 712A provides current time, day, and date. With a user input device, a user can select program listings by moving highlight region 710. Information relating to the program listing selected by highlight region 710 may be provided in program information region 712B. Region 712B may include, for example, the program title, the program description, the time the program is provided (if applicable), the channel the program is on (if applicable), the program's initial rating, a brief description of environmental factors (or a link to content contributing to environmental factors) associated with the rating (if applicable), and other desired information.

For example, from region 712A, the current time, day, and date is 12:44 pm on Friday, Mar. 31, 2006 and region 712B is displaying program listing information associated with highlight region 710. Region 712B may describe environmental factors or may provide a link to environmental factors that may be influencing a user's opinion. The highlight region 710, is on “The Simpsons,” and region 712B displays a repeat episode, “Kamp Krusty,” to be shown at 7 pm with an initial rating of 4 out of 5 stars. This information is generated by control circuitry 304 and transmitted for display on user equipment device 300 by display 312. With a user input device, a user can select the rating icon 728 from options region 726 of the interactive media guidance application to rate the program associated with highlight region 710. The control circuitry 304 processes the user input and generates an overlay display 730 for display on user equipment device 300 by display 312. The overlay display 730 has several user selectable options using a user input device. The user may scroll up/down to select an option from overlay display 730. From the overlay display 730, a user selection to “Rate Program” is transmitted from the user input device to the user equipment device 300. The control circuitry 304 receives user input to rate the program and transmits instructions to display overlay rating display 732 for display on user equipment device 300 by display 312 as an overlay onto interactive media guidance display 700. The user selects the rating using the left/right scroll buttons on a user input device. The user content rating is transmitted from the user input device to the user equipment device 300. The control circuitry 304 receives user content rating of the program and stores the media asset rating in a data structure in storage 308 in control circuitry 304 which is different from the first data structure in storage 308 storing media asset rating of the initial release. The first data structure in storage 308 storing the media asset rating of the initial release does not change after the threshold period of time has been reached. The data structure in storage 308 storing the media asset rating of the rerelease dynamically changes because the media asset rating of the rerelease are based on the current time period and environmental factors. The current time period and environmental factors influencing the rerelease media asset rating may be different from the initial time period and initial environmental factors influencing the initial media asset rating.

For example, the user rates “The Simpson” program, repeat episode “Kamp Krusty” with a 3 out of 5 stars. The rating system in overlay rating display 732 is one embodiment. In some embodiments, the rating system may be numerically based. For example, user rating of content may be on a scale from 1 to 10 or a percentage from 1 to 100%. In other embodiments, the rating system may be graded. For example user rating of content may be A, B, C, D, and F, with additional plus/minus ratings input by the user, using the user input device. The rating system may be different based on the media content. For example, Internet-based content rating may be based on the number of views, and on-demand content may be based on the number of orders to view the content.

The user rating for the rereleased program may be stored in a data structure in storage 308 which is different from the first data structure in storage 308 which stores the user ratings of the initial program release. A remote server, having hardware as described in FIG. 3, receives the user rating which may be stored in the data structure in storage 308. The remote server computes an average of the user rating from a plurality of user ratings stored in the data structure in storage 308 for the rereleased program. The remote server computes the average user rating of the rerelease program after the threshold period of time configured by the control circuitry 304 for the initial program release has passed. The plurality of user ratings are received from a plurality of user equipment devices 300, wherein a user inputs a rating using a user input device. The computed average of the user ratings for the rereleased media asset is transmitted for storage in the data structure of storage 308. The computed average of the rereleased user rating is transmitted for storage in the data structure in storage 308, which is different from the first data structure in storage 308. The computed average of the initial release of the media program stored in the first data structure in storage 308 will not change after the threshold time period configured by the control circuitry 304 has passed. The control circuitry 304 transmits the computed average of the rereleased user rating for display on user equipment device 300 by display 312. The visual indicator 710A is the computed average of the initial user rating displayed on the interactive media guidance application. The computed average initial user ratings may be the media content ratings as shown in 712B. In some embodiments, the program may have been rereleased several times. The visual indicator 710B is the computed average of the rereleased user rating displayed on the interactive media guidance application. The computed average of the rereleased user rating is based on a plurality of user ratings collected from the overlay ratings display 732, stored in a set time period data structure in storage 308, and computed at the control circuitry 304 from a plurality of user equipment device 302.

For example, after the initial film release of “Armageddon” in movie theaters in 1998, the film may have been rereleased on-demand by HBO in 2000, followed by a syndicated rerelease by a media content source, such as NBC, in 2003, and another syndicated rerelease by TNT in 2010. The user rating of “Armageddon” for each release time period may be stored in storage 308 in a specific data structure of control circuitry 304. Therefore, in this example, “Armageddon” has a data structure containing user ratings and the computed average user rating for each release date of 1998, 2000, 2003 and 2010. The time period set at the control circuitry 304 determines the computed average user rating for the media asset for display. The threshold time period established by the initial release may determine the initial user rating for the media asset. The user rating of the initial release of the media asset is stored in the first data structure in storage 308 associated with the media asset. Environmental factors influencing a user's opinion of “Armageddon” may be due to news stories related to an asteroid heading toward earth during the time period “Armageddon” was initially released. The stored user rating of the initial release does not change after the current time is equal to or greater than the threshold period of time configured by the control circuitry 304. After the threshold time period has passed, user rating for the rerelease of the media asset may change dynamically based on the time period and environmental factors influencing a user's opinion of the media asset. The user rating of the rerelease of the media asset is stored in a data structure associated with the media asset that is different from the first data structure, in storage 308. The user rating of the rerelease of the media asset may be stored in the data structure and the remote server, as discussed above, continues to compute the average user rating of the rerelease of the media asset.

User rating information for the initial release and subsequent rerelease of the media asset generates a visual indication of computed average user rating for the media asset for a set time period by control circuitry 304 and transmitted for display on user equipment device 300 by display 312. The control circuitry 304 generates a visual indicator 710B of the computed user rating of the media asset for display on the interactive media guidance application. The visual indicator 710A is of the initial computed program rating when it was initially released for broadcast. The control circuitry 304 transmits the visual indicator 710A and 710B based on the remote server, as described above, computing the initial and rerelease user ratings. The control circuitry 304 transmits the initial and rerelease user rating information to user equipment device 300 for display on display 312. In some embodiments, the user rating information may be numerical ratings, percentage ratings, graded ratings or a color-coded rating. In some embodiments, a combination of user rating information may be transmitted by the control circuitry 304 to user equipment device 300 for display on display 312.

For this example, from region 712B, the computed rating information for when “The Simpsons” episode “Kamp Krusty” was initially released for broadcast was 4 out of 5 stars. The current, in year 2006, program rating of “Kamp Krusty,” which is approximately 14 years after the initial broadcast date, is 3 out of 5 stars. Region 712B may describe environmental factors or may provide a link to environmental factors that may be influencing a user's opinion of “The Simpsons” episode “Kamp Krusty.” The user rating of the initial release of the media asset, which is 4 out of 5 stars in this example, is stored in the first data structure in storage 308 associated with the media asset. The stored user rating of the initial release does not change after the current time is equal to or greater than the threshold period of time configured by the control circuitry 304. After the threshold time period has passed, user rating for the rerelease of the media asset may change dynamically based on the time period and environmental factors influencing a user's opinion of the media asset. The user rating of the rerelease of the media asset, 3 out of 5 stars in this example, is stored in a data structure associated with the media asset that is different from the first data structure, in storage 308. The user rating of the rerelease of the media asset may be stored in the data structure and the remote server, as discussed above, continues to compute the average user rating of the rerelease of the media asset. After the threshold time period has passed, the computed average user rating for the rerelease of the media asset by the remote server, as described above and in FIG. 3, may change dynamically based on the time period and environmental factors influencing a user's opinion of the media asset. For this example, the threshold time period may be when a new season of “The Simpsons” airs. Other embodiments may be immediately after the episode “Kamp Krusty” was initially released, or may be after “The Simpsons” became syndicated, or may be after five years since the initial release of “Kamp Krusty.” During the 14 years between the initial release and rerelease of “The Simpsons” episode “Kamp Krusty,” several environmental factors may have affected a user's opinion of the media content. Environmental factors which impact how a user's opinion of media content will be influenced may include topical news, social/political trends, popular sports, popular fashion, and cutting edge technology. The future rerelease of the episode “Kamp Krusty” may have a different set of user ratings based on user opinions, which may be influenced by environmental factors at the time of the rerelease.

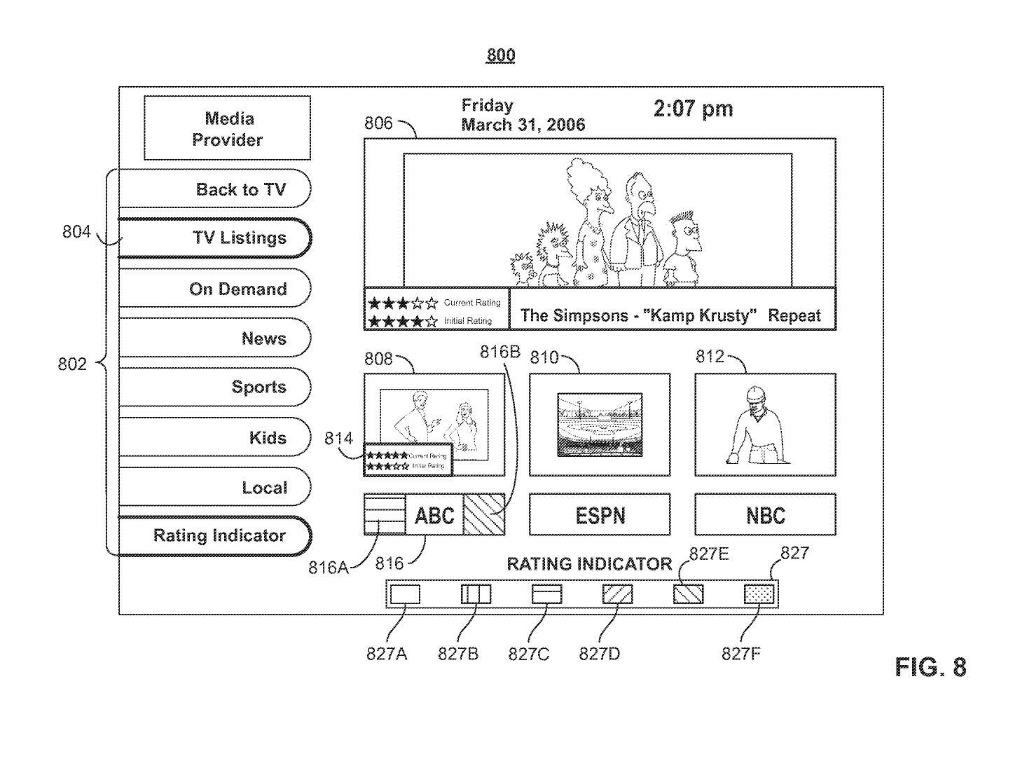

Another display arrangement for providing media guidance is shown in FIG. 8. Video mosaic display 800 may be similar to the video mosaic display 200 and video mosaic display 600 as described above. Video mosaic display 800 includes current time, day, and date information and selectable options 802 for content information organized based on content type, genre, and/or other organization criteria. In display 800, television listings option 804 is selected, thus providing listings 806, 808, 810, and 812 as broadcast program listings. In display 800 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. In listing 806 program information, including ratings, may be displayed.

For example, in listing 806, the repeat episode, “Kamp Krusty,” of “The Simpsons,” has an initial broadcast rating of 4 out of 5 stars and a current retransmit rating of 3 out of 5 stars displayed. Additionally, like listing 806, listing 808 may include more than one portion, including media portion 814 and text portion 816. Media portion 814 and/or text portion 816 may be selectable to view content in full-screen or to view information related to the content displayed in media portion 814 (e.g., to view listings for the channel that the video is displayed on). In display 800, rating indicator option may be selected to show the visual indicator guide representing user ratings of the media asset. For example, the program ratings information may be visually indicated in media portion 814 as a star rating and separately a visual indication in the text portion 816 as a color-coded rating. The visual indicators are representative of the initial rating and rereleased rating. In some embodiments, the information may be displayed in numerical format, grading format, or a gradient color-code representative of the user ratings of the media content. The control circuitry 304 transmits the initial and rerelease user rating information to user equipment device 300 for display on display 312. In some embodiments, the user rating information may be numerical ratings, percentage ratings, graded ratings or a color-coded rating. In some embodiments, a combination of user rating information may be transmitted by the control circuitry 304 to user equipment device 300 for display on display 312. In FIG. 8, the program ratings information may be visually indicated in media portion 814 and separately a visual indication of program ratings information in the text portion 816 for both the initial rating and separately for the current retransmit rating.

The rating indicator region 827 may provide a visual guide representing user ratings of the media asset in display 100. The visual indicators 827A-827E represent a visual range of user rating based on a user rating scale configurable by control circuitry 304. The user rating scale may be any configurable rating system, such as a numerical rating system, a percentage rating system, a graded rating system, a star rating system or a color-coded rating system, as described above.

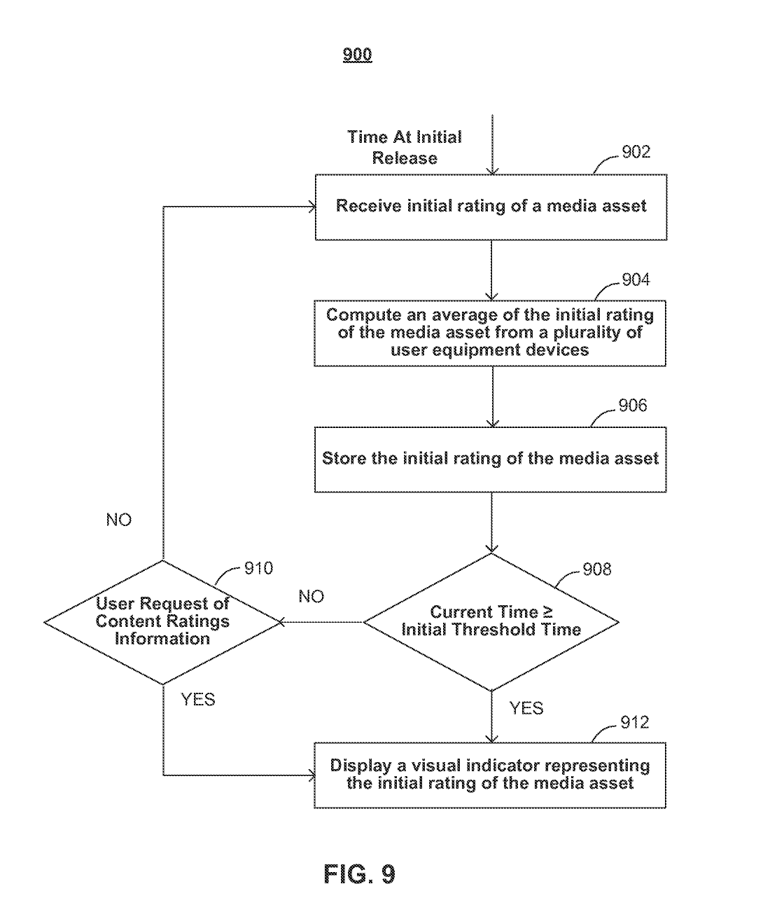

FIG. 9 is a flowchart of illustrative steps involved in displaying the media content rating for a media asset which is initially released in accordance with some embodiments of the disclosure. In some embodiments, FIG. 9 may be incorporated into process 500 (FIG. 5). For example, process 900 may describe the method used to generate a media content rating as described in relation to highlight region 510 and ratings display 532 (FIG. 5). It should be noted that process 900 or any step thereof, could be displayed on, or provided by, any of the devices shown in FIGS. 3-4. For example, process 900 may be executed by control circuitry 304 (FIG. 3) as instructed by the interactive media guidance application.

FIG. 9 shows process 900. The threshold period of time may be set at the control circuitry 304 or at the user equipment device 300. In some embodiments, the threshold period of time or threshold time may correspond to a length of time measured from when the media asset is first made available from a first source to when the media asset is made available from a second source different from the first source. For example, the first source may be a theatrical release and the second source may be a DVD release. In some embodiments, the threshold period of time corresponds to a length of time measured from when the media asset is first released to when the media asset is syndicated. In some embodiments, the threshold period of time corresponds to a length of time measured from when the media asset is released live and when an encore presentation of the media asset is released. In some embodiments, the threshold period of time corresponds to a length of time measured from the initial release of a seasonal media asset to the end of the season. For example, a winter holiday song may have a threshold period of four months. In some embodiments, the threshold period of time corresponds to a length of time measured between a current season of a media asset and the next season of a media asset. For example, the third season of “The Simpsons” and the fourth season of “The Simpsons.” In some embodiments, the threshold period of time corresponds to a length of time measured from the initial release of a media asset and the remake initial release of the media asset. For example, the 1980s show “Knight Rider” and the remake of the show in the 2000s. In some embodiments, the threshold period of time corresponds to a length of time measured from the initial release of the media asset in a first media asset and the initial release of the media asset as a second media asset. For example, the time period between the initial release of a song by an artist and the music video release by the artist. In some embodiments, the threshold period of time corresponds to a length of time measured from the initial release of a condensed version of media asset to the complete version of the media asset. For example, the time period between the initial movie preview release on the Internet and the movie premiere in theaters.

At step 902, the interactive media guidance application receives a initial rating of a media asset for a highlight region 510 (FIG. 5) of an initially released media asset. At step 904, the remote server, as described above and in FIG. 3, computes an average of the initial ratings of the media asset. The computed average is based on receiving a plurality of initial ratings of the media asset from a plurality of user equipment devices 300. At step 906, the initial ratings of the media asset may be stored in a first data structure in storage 308. In some embodiments, the interactive media guidance application may store the initial ratings of the media asset.

At step 908, the control circuitry 304 determines if the current time is greater than or equal to a threshold period of time configured by the control circuitry 304 or at the user equipment device 300.

At step 908, if the control circuitry 304 determines the current time is greater than or equal to the threshold time period, then at step 912, the control circuitry 304 transmits instructions to user equipment device 300 to display the initial rating of the media asset, using a visual indicator for display by display 312. The visual indicator is based on ratings information as described above. For example, visual indicator region 510A in FIG. 5 shows the initial rating for the program “The Simpsons,” after the user rating is received from overlay rating display 532.

At step 908, if the control circuitry determines the current time is less than the threshold time, then at step 910, the control circuitry 304 determines if a user request of content ratings information is received from the user equipment device 300 transmitted by a user input device from a user.

At step 910, if the control circuitry determines a user request of content ratings information is received, then at step 912, the control circuitry 304 transmits instructions to user equipment device 300 to display the initial rating of the media asset. For example, the media portion 614 and text portion 616 in FIG. 6 has a visual indicator of the initial rating for the ABC program listing 608.

At step 910, if the control circuitry 304 determines a user request of content ratings information is not received from the user equipment device 300 transmitted by a user input device from a user, the control circuitry 304 continues receiving initial ratings of the media asset from a plurality of user equipment devices 300. For example, overlay rating display 532 in FIG. 5 shows a four out of five stars rating for the program “The Simpsons” in highlight region 510.

After the current time passes the threshold period of time or threshold time, the control circuitry 304 may not receive initial ratings of the media asset from a plurality of user equipment devices 300. The initial ratings are stored in a first data structure in storage 308, as described above. The computed average initial ratings stored in the first data structure in storage 308 may not change.

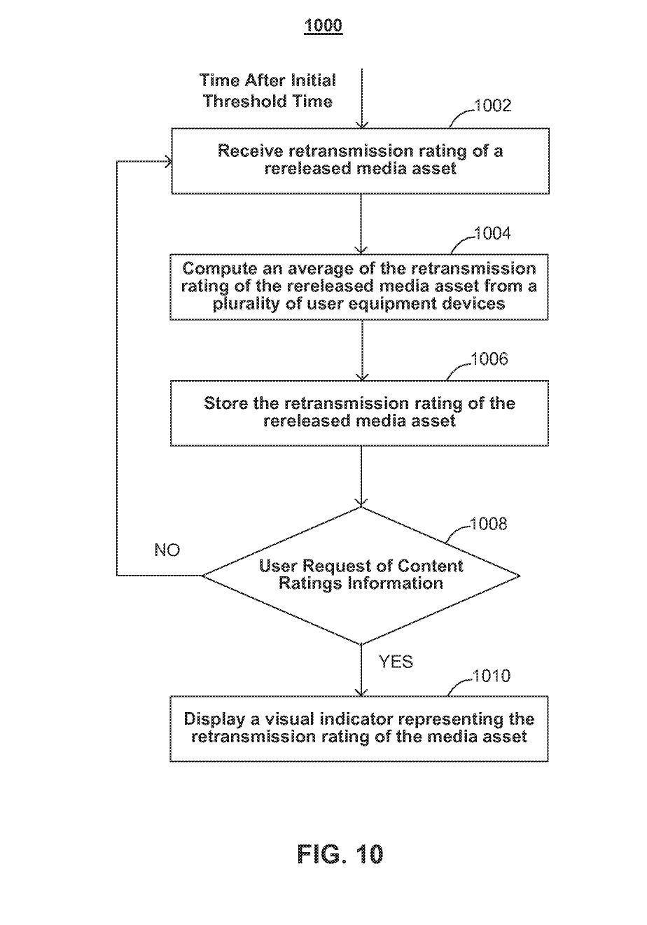

When the media asset in process 900 of FIG. 9 is retransmitted, the control circuitry 304 may receive retransmission ratings of the media asset. FIG. 10 is a flowchart of illustrative steps involved in simultaneously displaying the retransmitted ratings of the media asset in process 900 of FIG. 9 in accordance with some embodiments of the disclosure. In some embodiments, FIG. 10 may be incorporated into, process 700 (FIG. 7). For example, process 1000 may describe the method used to generate a media content rating as described in relation to highlight region 710 and ratings display 732 (FIG. 7). It should be noted that process 1000 or any step thereof, could be displayed on, or provided by, any of the devices shown in FIGS. 3-4. For example, process 1000 may be executed by control circuitry 304 (FIG. 3) as instructed by the interactive media guidance application.

FIG. 10 shows process 1000. The current threshold period of time or time period corresponds to the retransmission of the media asset, which may be set at the control circuitry 304 or the user equipment device 300. In some embodiments, the threshold period of time may correspond to a length-of-time measure from when the media asset is first made available from a first source to when the media asset is made available from a second source different from the first source. For example, the first source may be a theatrical release and the second source may be a DVD release. In some embodiments, the threshold period of time corresponds to a length of time measured from when the media asset is first released to when the media asset is syndicated. In some embodiments, the threshold period of time corresponds to a length of time measure from when the media asset is released live and when an encore presentation of the media asset is released.

At step 1002, the interactive media guidance application receives a retransmitted rating of the media asset for a highlight region 710 (FIG. 7) of a retransmitted media asset. The threshold time or threshold time period is set by the control circuitry 304 or at the user equipment device 302. The threshold time or threshold time period may be stored in storage 308. For process 1000, the threshold time is set to be the initial release of the media asset, as shown in process 900.

At step 1004, the remote server, as described above and in FIG. 3, computes an average of the retransmitted ratings of the media asset. The computed average is based on receiving a plurality of retransmission ratings of the media asset from a plurality of user equipment devices 300. For example, overlay rating display 732 receives a user retransmission rating for the program, “The Simpsons” in highlight region 710.

At step 1006, the retransmission ratings of the media asset are stored in a data structure in storage 308, which is different from the first data structure storing the initial ratings of the media asset in storage 308. In some embodiments, the interactive media guidance application may store the retransmission ratings of the retransmitted media asset.

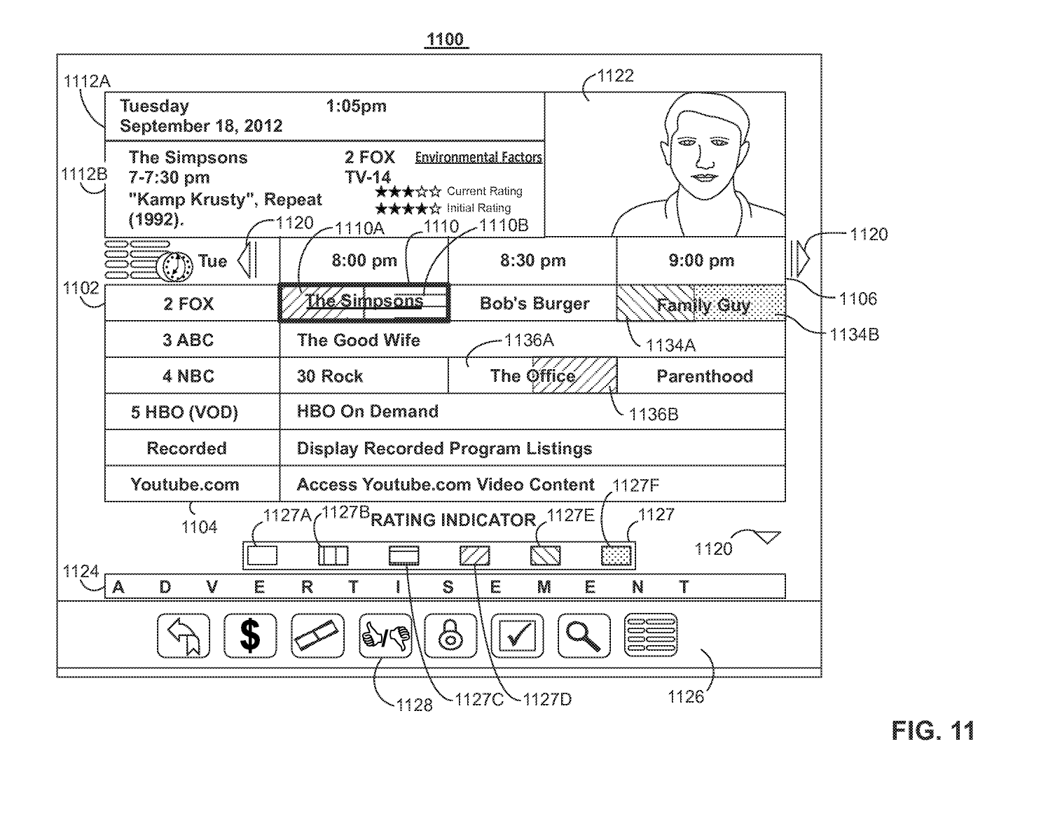

At step 1008, the control circuitry 304 determines if a user request of content ratings information is received from the user equipment device 300 transmitted by a user input device from a user. At step 1008, if the control circuitry determines a user request of content ratings information is received, then at step 1010, the control circuitry 304 transmits instructions to user equipment device 300 to display the retransmission rating of the media asset simultaneously to the control circuitry 304 transmitted instructions to user equipment device 300 to display the initial rating of the media asset as described in process 900 of FIG. 9. For example, the program “The Simpsons,” as described above has a visual indicator 1110B in FIG. 11 for the retransmission rating, which is displayed simultaneously with the initial rating represented as visual indicator 1110A.

At step 1008, if the control circuitry 304 determines a user request of content ratings information is not received from the user equipment device 300 transmitted by a user input device from a user, the control circuitry 304 continues receiving retransmission ratings of the media asset from a plurality of user equipment devices 300. The control circuitry 304 transmits instructions to the user equipment device 300 to continue to display the initial rating of the media asset as described in process 900 of FIG. 9. For example, the program “The Simpsons,” as described above has a visual indicator 710A in FIG. 7 for the initial rating, which is displayed while user retransmission rating information is received from a user input device, in overlay rating display 532.

As more and more users re-discover previously broadcast programs and view content 1-20 years after their original release date of the program, an updated rating of the rebroadcasted program may be more appropriate in informing the user when program viewing decisions are made. The retransmitted programs viewed and rated by the user at a later date are important because the ratings are not influenced by the same set of environmental factors which influenced the initial program ratings. Therefore, a more appropriate current set of program ratings, in addition to the initial program ratings, would provide a user with improved information when making a program viewing decision.

For example, the 1980s television show “Miami Vice” was very popular because of the actors, the fashion, and storyline, and received high user ratings when the show was initially released. A description or link to environmental factors influencing a user's opinion of “Miami Vice” may be provided as described above, and shown in Region 712B of FIG. 7. Similar shows in the 1980s included “The A-Team” and “Knight Rider.” Rerelease or reruns of “Miami Vice” in 2012 may not receive the same user ratings due to a changed influence of environmental factors which include topical news, social/political trends, popular sports, popular fashion, and cutting edge technology. In the example of “Miami Vice,” changes in popular fashion and social trends may influence a user's rating of the program.

As another example, “The A-Team” film was released in 2010 based on the 1980s television show “The A-Team.” The film was made based on initial popularity of the 1980s television show. Thus, user opinion's of media content based on environmental factors at a set time, may have future influence on the media content that is produced for viewing by the user. In the example of “The A-Team” the program, user ratings may have influenced the production of “The A-Team” film. In addition, because of the film release, the “The A-Team” program rerelease may have equally high ratings as when the “The A-Team” program was initially released. A description or link to environmental factors influencing a user's opinion of “The A-Team” show and subsequent film may be provided as described above, and shown in Region 712B of FIG. 7.

FIG. 11 shows illustrative grid program listings display 1100 arranged by time and channel that also enables access to different types of content in a single display. Display screen 1100 may be similar to the display screen 100, display screen 500, and display screen 700 as described above. Display 1100 may include grid 1102 with: (1) a column of channel/content type identifiers 1104, where each channel/content type identifier (which is a cell in the column) identifies a different channel or content type available; and (2) a row of time identifiers 1106, where each time identifier (which is a cell in the row) identifies a time block of programming. Grid 1102 also includes cells of program listings, such as program listing 1108, where each listing provides the title of the program provided on the listing's associated channel and time. Region 1112A provides current time, day, and date. With a user input device, a user can select program listings by moving highlight region 1110. Information relating to the program listing selected by highlight region 1110 may be provided in program information region 1112B. Region 1112B may include, for example, the program title, the program description, the time the program is provided (if applicable), the channel the program is on (if applicable), the program's computed average initial rating, the program's computed average current rating, a brief description of environmental factors (or a link to content contributing to environmental factors) associated with the rating (if applicable), and other desired information.

For example, from region 1112A, the current time, day, and date is 1:05 pm on Tuesday, Sep. 18, 2012 and region 1112B is displaying program listing information associated with highlight region 1110. The highlight region 1110, is on “The Simpsons,” and region 1112B displays a repeat episode, “Kamp Krusty,” to be shown at 7 pm with a computed average initial rating of 4 out of 5 stars and a computed average current rating of 3 out of 5 stars. Region 1112B may describe environmental factors or may provide a link to environmental factors that may be influencing a user's opinion. This information is generated by control circuitry 304 and transmitted for display on user equipment device 300 by display 312.

The interactive media guidance display 1100, 700, 500, 100, and its other embodiments 800, 600, and 200 may have varying display configurations based on the user equipment device 300 which will display the interactive media guidance display. The color configuration and display options for optimal display on user equipment is stored in storage 308 and processing circuitry 306 determines the appropriate display configuration. The control circuitry 304 transmits this information for display on user equipment device 300 by display 312 onto the interactive media guidance display.

The highlight region 1110 shows visual indicator 1110A and 1110B. Visual indicator 1110A is the visual representation of the computed average initial rating by the remote server, as described above and in FIG. 3. The control circuitry 304 transmits the computed average initial rating information from the data structure storing the initial ratings information in storage 308. The processing circuitry 306 determines the appropriate visual indicator to transmit for display on user equipment device 300 by display 312 onto interactive media guidance display 1100 based on the display configuration of user equipment device 300. Visual indicator 1110B is the visual representation of the computed average current rating. The control circuitry 304 transmits the computed average current rating information from another data structure storing the current ratings information in storage 308. The processing circuitry 306 determines the appropriate visual indicator to transmit for display on user equipment device 300 by display 312 onto interactive media guidance display 1100 based on the display configuration of user equipment device 300. The user rating for the initially released program may be stored in a first data structure in storage 308. A remote server, having hardware as is described in FIG. 3, receives the user rating which may be stored in the first data structure in storage 308. The remote server computes an average of the user rating from a plurality of user ratings stored in storage 308 for the initially released program. The remote server continues to compute the average user rating of the initially released program until the threshold period of time configured by the control circuitry 304 has been reached. The plurality of user ratings are received from a plurality of user equipment devices 300, wherein a user inputs a rating using a user input device. The computed average of the user ratings for the initially released media asset is transmitted for storage in the first data structure of storage 308. The computed average of the user ratings for the initially released media asset stored in the first data structure of storage 308 will not change after the difference between the current time and the threshold period of time of the initial release configured by the control circuitry is equal or greater.

Visual indicators, such as 1110A and 1132A are the visual representation of the computed average initial rating by the remote server, as described above and in FIG. 3. The control circuitry 304 transmits the computed average initial rating information from the data structure storing the initial ratings information in storage 308. The processing circuitry 306 determines the appropriate visual indicator to transmit for display on user equipment device 300 by display 312 onto interactive media guidance display 1100 based on the display configuration of user equipment device 300.

Visual indicators, such as 1110B and 1132B, are the visual representation of the computed average retransmission rating. The control circuitry 304 transmits the computed average retransmission rating information from another data structure storing the current ratings information in storage 308. The processing circuitry 306 determines the appropriate visual indicator to transmit for display on user equipment device 300 by display 312 onto interactive media guidance display 1100 based on the display configuration of user equipment device 300.

User rating for the initially released program may be stored in a first data structure in storage 308. A remote server, having hardware as in described in FIG. 3, receives the user rating which may be stored in the first data structure in storage 308. The remote server computes an average of the user rating from a plurality of user ratings stored in storage 308 for the initially released program. The remote server continues to compute the average user rating of the initially release program until the threshold period of time configured by the control circuitry 304 has been reached. The plurality of user ratings are received from a plurality of user equipment devices 300, wherein a user inputs a rating using a user input device. The computed average of the user ratings for the initially released media asset is transmitted for storage in the first data structure of storage 308. The computed average of the user ratings for the initially released media asset stored in the first data structure of storage 308 will not change after the difference between the current time and the threshold period of time of the initial release configured by the control circuitry is equal or greater.

The visual indicator 1134B for the program “Family Guy” has a color-code corresponding to visual indicator 1127F of rating indictor 1127. The visual indicator 1134A for the program gives an approximate five out of five star rating. Therefore, the visual indicator 1134B represents the initial rating and rerelease rating for the program “Family Guy” is substantially equal and approximately rated five out of five stars. Rating indictor region 1127, as described above in region 127 of FIG. 1, shows a visual guide representing user ratings of the media asset in display 1100. The visual indicators 1127A through 1127E represent a visual range of user ratings based on a user rating scale which is configurable by control circuitry 304, as described above. The user rating scale may be any configurable rating system, such as a numerical rating, a percentage rating, a graded rating, a star rating system or a color-coded rating system, as described above. In this example, the visual indictor 1134A and 1134B has rating information corresponding to the program “Family Guy” that displays visual information of the initial user rating of the program and the rerelease user rating of the program are substantially equal. Since the highlight region 1110 is on the program “The Simpsons,” region 1112B displays program information related to the highlight region 1110. Region 1212B may describe environmental factors or may provide a link to environmental factors that may be influencing a user's opinion. When a user scrolls the highlight region 1110 left two cells to the program “Family Guy,” region 1112B will display program information related to “Family Guy.” In this example, since the highlight region 1110 is not on the program “Family Guy” the visual indicator 1130 for the program “Family Guy” provides the user an approximate indication of user rating information for the media asset when it was initially released and when it was rereleased.

The visual indicator 1136A for the program “The Office” has color-coded rating information corresponding to visual indicator 1127B of rating indicator region 1127. The visual indicator 1136B for the program “The Office” has color-coded rating information corresponding to visual indicator 1127D. Therefore, the initial rating, represented by visual indicator 1132A, for “The Office” may be approximately equal to two out of five stars. Furthermore, the current rating, represented by visual indicator 1132B, for “The Office” may be approximately equal to four out of five stars. For this example, because the highlight region 1110 is not highlighting “The Office,” a user may not be able to know the detailed rating information for “The Office.” The visual indicators 1132A and 1132B may provide the user with an approximate indication of the rating for the media asset, “The Office.” When a user scrolls the highlight region 1110 down two cells, and left one cell to the program “The Office,” region 1112B will display program information related to “The Office.”

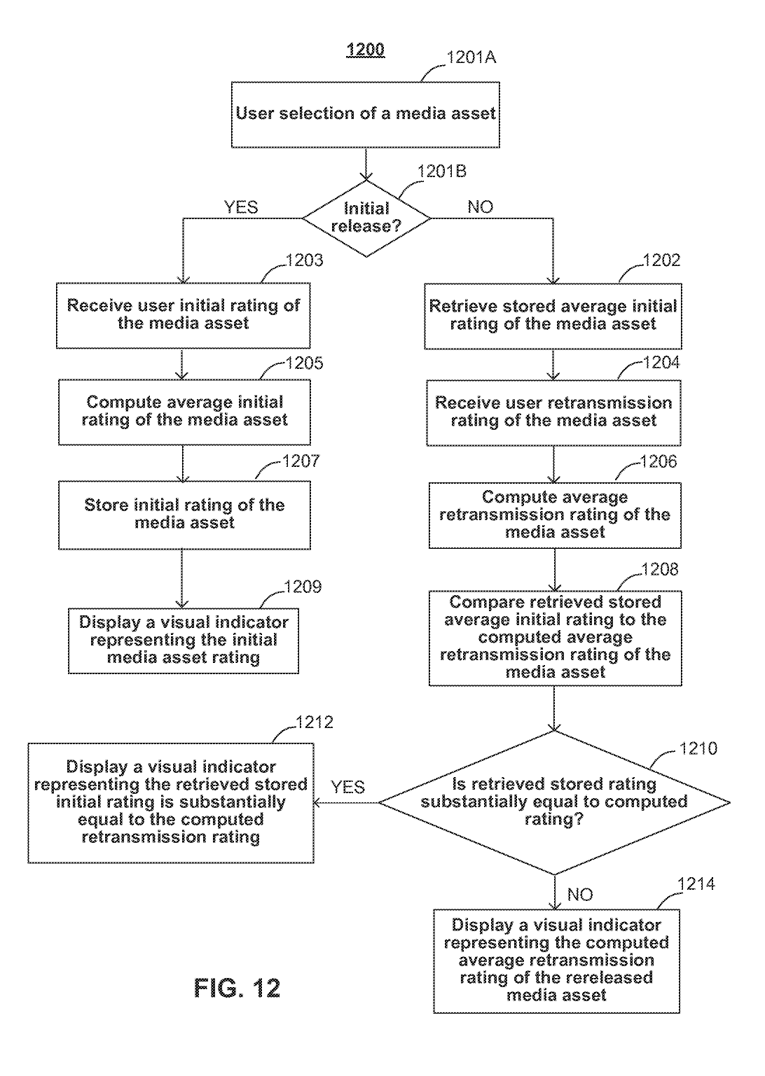

FIG. 12 is a flowchart of illustrative steps involved in using an interactive media guidance application to generate a simultaneous display of media content ratings for the same media asset with visual indicators for when the media asset was initially released or retransmitted or the ratings were substantially equal.

FIG. 12 shows process 1200. At step 1201A, the interactive media guidance application receives user selection of a media asset. At step 1201B, the control circuitry 304 determines if the media asset is the first broadcast.

At step 1203, similar to step 902 as described above, if the control circuitry 304 determines the media asset is the initial release, the control circuitry 304 receives a user rating of the media asset. Next, at step 1205, similar to step 904 as described above, the remote server, as described above and in FIG. 3, computes ratings of the media asset from the plurality of user equipment devices. At step 1207, similar to step 906 as described above, the rating of the media asset is stored in a data structure. At step 1209, similar to step 912 as described above, the control circuitry 304 generates a display of a visual indicator representing the initial media asset rating.

At step 1202, after the control circuitry 304 determines the media asset is a retransmission, the control circuitry 304 retrieves the stored rating of the media asset from the data structure. At step 1204, similar to step 1002 as described above, the user receives the user rating of the media asset. Next, at step 1206, similar to step 1004 as described above, the remote server, as described above and in FIG. 3, computes ratings of the media asset from the plurality of user equipment devices. At step 1208, the retrieved stored initial rating from step 1202 is compared to the computed retransmission rating from step 1206. Next, the control circuitry 304, determines if the retrieved stored rating 1202 is substantially equal to computed rating 1206 of the media asset. At step 1212, the control circuitry 304 generates a display of a visual indicator representing the retrieved stored rating being substantially equal to the computed rating. In the instance the retrieved stored rating may be substantially equal to the computed rating, the computed average rating information for either the initial or rereleased user rating information is transmitted by control circuitry 304 to the user equipment device 300 for display on display 312. For example, visual indicator 1134B in FIG. 11, shows the initial rating of five out of five stars, as represented by visual indicator 1134A, for the program “Family Guy” is substantially equal. The visual indicator for substantially equal ratings of initial and rerelease rating information may be represented as 127F in FIG. 1, as described above. At step 1214, the control circuitry 304 generates a display of a visual indicator representing the media asset rating.

It should be understood that the above steps of the flow diagrams of FIGS. 9, 10, and 12 may be executed or performed in any order or sequence not limited to the order and sequence shown and described in the figures. Also, some of the above steps of the flow diagrams of FIGS. 9, 10, and 12 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for providing media asset ratings in an interactive media guidance application display on a device, the method comprising:
computing a first media asset rating based on a plurality of first media asset ratings received when the media asset is made available to a plurality of users;
storing the first media asset rating in a first data structure after the media asset has been made available to a plurality of users for a threshold period of time;
after the media asset has been made available to the plurality of users for the threshold period of time, computing a second media asset rating based on a plurality of second media asset ratings received after the threshold period of time, wherein the second media asset rating is computed independently of the first media asset rating;
storing the second media asset rating in a second data structure; and
generating a display representing the first media asset rating and the second media asset rating based on the first and second data structures.

2. The method of claim 1, wherein computing the first media asset rating comprises computing an average of the first plurality of media asset ratings.

3. The method of claim 1, wherein the first media asset rating stored in the first data structure does not change after the threshold period of time, and wherein the second media asset rating stored in the second data structure dynamically changes based on further media asset ratings received after the threshold period of time.

4. The method of claim 1, wherein the media asset is first made available from a first source, and wherein the threshold period of time corresponds to a length of time measured from when the media asset is first made available from the first source to when the media asset is made available from a second source different from the first source.

5. The method of claim 4, wherein the first source is a movie theater and the second source includes a secondary form of distribution to a user.

6. The method of claim 5, wherein the secondary form of distribution includes transmission of the media asset to a plurality of user equipment devices from a server and storage of the media asset on a digital storage device accessible to a user.

7. The method of claim 1, wherein the threshold period of time corresponds to a length of time measured from when the media asset is first made available to when the media asset is syndicated.

8. The method of claim 1, wherein generating the display comprises generating a simultaneous display of the first media asset rating and the second media asset rating in which the first media asset rating is visually distinguished from the second media asset rating.

9. The method of claim 8, wherein the first media asset rating generated for display in a first color and the second media asset rating is generated for display in a second color.

10. The method of claim 1 further comprising:
determining whether the first media asset rating is substantially equal to the second media asset rating; and
in response to determining the first media asset rating is substantially equal to the second media asset rating, generating in the display representing the first media asset rating and the second media asset rating a visual indicator that indicates the first media asset rating is substantially equal to the second media asset rating.

11. A system for providing media asset ratings in an interactive media guidance application display on a device, the system comprising:
control circuitry configured to:
compute a first media asset rating based on a plurality of first media asset ratings received when the media asset is made available to a plurality of users;
store the first media asset rating in a first data structure after the media asset has been made available to a plurality of users for a threshold period of time;
after the media asset has been made available to the plurality of users for the threshold period of time, compute a second media asset rating based on a plurality of second media asset ratings received after the threshold period of time, wherein the second media asset rating is computed independently of the first media asset rating;
store the second media asset rating in a second data structure; and
generate a display representing the first media asset rating and the second media asset rating based on the first and second data structures.

12. The system of claim 11, wherein the control circuitry is further configured to compute the first media asset rating comprises computing an average of the first plurality of media asset ratings.

13. The system of claim 11, wherein the first media asset rating stored in the first data structure does not change after the threshold period of time, and wherein the second media asset rating stored in the second data structure dynamically changes based on further media asset ratings received after the threshold period of time.

14. The system of claim 11, wherein the media asset is first made available from a first source, and wherein the threshold period of time corresponds to a length of time measured from when the media asset is first made available from the first source to when the media asset is made available from a second source different from the first source.

15. The system of claim 14, wherein the first source is a movie theater and the second source includes a secondary form of distribution to a user.

16. The system of claim 15, wherein the secondary form of distribution includes transmission of the media asset to a plurality of user equipment devices from a server and storage of the media asset on a digital storage device accessible to a user.

17. The system of claim 11, wherein the threshold period of time corresponds to a length of time measured from when the media asset is first made available to when the media asset is syndicated.

18. The system of claim 11, wherein generating the display comprises generating a simultaneous display of the first media asset rating and the second media asset rating in which the first media asset rating is visually distinguished from the second media asset rating.

19. The system of claim 18, wherein the first media asset rating generated for display in a first color and the second media asset rating is generated for display in a second color.

20. The system of claim 11 wherein the control circuitry is further comprising:
determine whether the first media asset rating is substantially equal to the second media asset rating; and
in response to determining the first media asset rating is substantially equal to the second media asset rating, generate in the display representing the first media asset rating and the second media asset rating a visual indicator that indicates the first media asset rating is substantially equal to the second media asset rating.

21.-30. (canceled)
